(19) United States
(12) Patent Application Publication
(10) Pub. No.: US 2024/0235241 A9
(43) Pub. Date: Jul. 11, 2024

(54) MOBILITY CHARGING DEVICE AND CHARGING METHOD USING THE SAME

(71) Applicants: HYUNDAI MOTOR COMPANY, Seoul (KR); KIA CORPORATION, Seoul (KR)

(72) Inventors: Ho Kwon Na, Dangjin-si (KR); Yong Kyu Yoo, Seongnam-si (KR); Jae Dong Shin, Hwaseong-si (KR)

(73) Assignees: HYUNDAI MOTOR COMPANY, Seoul (KR); KIA CORPORATION, Seoul (KR)

(21) Appl. No.: 18/224,096

(22) Filed: Jul. 20, 2023

(30) Foreign Application Priority Data
Oct. 19, 2022 (KR) 10-2022-0134970

(51) Int. Cl. H02J 7/00; B60L 53/30; B60L 53/62

(52) U.S. Cl. CPC H02J 7/007182; B60L 53/30; B60L 53/62

(57) ABSTRACT

A mobility charging device comprises a measurement unit configured to measure a voltage of a battery of a mobility device when the mobility device is electrically connected to an input/output interface, a determination unit configured to receive the voltage of the battery from the measurement unit, and determine a charging mode among a plurality of charging modes according to the voltage of the battery, and a charging unit configured to differently set cut-off voltages correspondingly to the plurality of charging modes, and provide charging voltage corresponding to a cut-off voltage set correspondingly to the charging mode to the mobility device through the input/output interface.

### CROSS-REFERENCE TO RELATED APPLICATION

The present application claims priority to Korean Patent Application No. 10-2022-0134970, filed on Oct. 19, 2022, the entire contents of which are incorporated herein by reference.

### TECHNICAL FIELD

The present disclosure relates to a mobility charging device and a charging method using the same. More specifically, the present disclosure relates to a mobility charging device and a charging method using the same, which are capable of determining battery information provided from a mobility device when the mobility device and the mobility charging device are connected.

### BACKGROUND

Recently, as interest in environmental issues such as global warming has increased, demands for reducing carbon dioxide emissions, which are the main cause of global warming, have increased, and demands for personal mobility devices powered by electricity have increased.

The personal mobility device consumes electric energy for driving the electric motor and should charge and use the battery when the personal mobility device travels all distances that can be traveled.

However, since the method of charging a battery varies according to the type of battery, personal mobility device, manufacturer, and the like, a user may be inconvenienced in selecting a correct charging option before charging the battery.

Therefore, when the battery of the personal mobility device is connected to the battery charging device, it is desired to automatically recognize and charge the battery by receiving battery information and charging the battery by a charging method corresponding to the received battery information.

### SUMMARY

Various aspects of the present disclosure are directed to providing a mobility charging device and a charging method using the same, which are capable of determining battery information provided from a mobility device and differently providing a charging voltage corresponding to a determined result value when the mobility device and a mobility charging device are coupled.

Technical problems to be solved by the present disclosure are not limited to the above-mentioned, and other technical problems not mentioned should be clearly understood by those having ordinary skill in the art from the following description.

According to an embodiment of the present disclosure, a mobility charging device comprises: a measurement unit configured to measure a voltage of a battery of a mobility device when the mobility device is electrically connected to an input/output interface; a determination unit configured to receive the voltage of the battery from the measurement unit, and determine a charging mode among a plurality of charging modes according to the voltage of the battery; and a charging unit configured to differently set cut-off voltages correspondingly to the plurality of charging modes, and provide charging voltage corresponding to a cut-off voltage set correspondingly to the charging mode to the mobility device through the input/output interface.

In at least one embodiment of the present disclosure, the plurality of charging modes includes a first charging mode, a second charging mode, a third charging mode, and a fourth charging mode. The determination unit may: determine the first charging mode when the measured voltage of the battery is included in a first charging range; determine the second charging mode when the measured voltage of the battery is included in a second charging range; determine the third charging mode when the measured voltage of the battery is included in a third charging range; and determine the fourth charging mode when the measured voltage of the battery is included in a charging range overlapping between the second charging range and the third charging range.

In at least one embodiment of the present disclosure, when the first charging mode is determined from the determination unit, the charging unit sets the cut-off voltage as a first voltage, recognizes the battery as a first type battery in response to the first voltage, and provides a first charging voltage to the mobility device.

In at least one embodiment of the present disclosure, when the second charging mode is determined from the determination unit, the charging unit sets the cut-off voltage as a second voltage, recognizes the battery as a second type battery in response to the set second voltage, and provides a second charging voltage to the mobility device.

In at least one embodiment of the present disclosure, when the third charging mode is determined from the determination unit, the charging unit sets the cut-off voltage as a third voltage, recognizes the battery as a third type battery in response to the set third voltage, and provides a third charging voltage to the mobility device.

In at least one embodiment of the present disclosure, the charging device further comprises a battery management unit configured to receive or extract battery information from the mobility device when the mobility device is electrically connected to the input/output interface.

In at least one embodiment of the present disclosure, when the fourth charging mode is determined from the determination unit, the battery management unit is configured to set the cut-off voltage as a second voltage or a third voltage based on the battery information.

In at least one embodiment of the present disclosure, when the second voltage set by the battery management unit is transmitted, the charging unit recognizes the battery as the second type battery in response to the transmitted second voltage, and provides a second charging voltage to the mobility device.

In at least one embodiment of the present disclosure, when the third voltage set by the battery management unit is transmitted, the charging unit recognizes the battery as a third type battery in response to the transmitted third voltage, and provides a third charging voltage to the mobility device.

In at least one embodiment of the present disclosure, the input/output interface comprises: a plurality of power terminals electrically connected to the mobility device; an indicator configured to display a charging state of the mobility device; and a connection unit configured to provide mobility information related to the mobility device.

According to an embodiment of the present disclosure, a mobility charging method using a mobility charging device having a processor includes: measuring a voltage of a battery of the mobility device under the control of the processor when the mobility device is electrically connected to an input/output interface; receiving the measured voltage of the battery under the control of the processor; determining a charging mode among a plurality of charging modes according to the measured voltage of the battery, and differently setting cut-off voltage corresponding to the plurality of determined charging modes under the control of the processor; and providing respective charging voltage corresponding to the differently set cut-off voltage to the mobility device through the input/output interface under the control of the processor.

In at least one embodiment of the method according to the present disclosure, the plurality of charging modes comprises a first charging mode, a second charging mode, a third charging mode, and a fourth charging mode. Determining a charging mode comprises: determining the first charging mode when the measured voltage of the battery is included in a first charging range of the preset charging range; determining the second charging mode when the measured voltage of the battery is included in a second charging range of the preset charging range; determining the third charging mode when the measured voltage of the battery is included in a third charging range of the preset charging range; and determining the fourth charging mode when the measured voltage of the battery is included in a charging range overlapping the second charging range and the third charging range.

In at least one embodiment of the method according to the present disclosure, providing respective charging voltage comprises: setting the cut-off voltage to a first voltage when the first charging mode is transmitted; recognizing the battery as a first type battery in response to the set first voltage; and providing a first charging voltage among respective charging voltages that are applicable to the recognized first type battery to the mobility device.

In at least one embodiment of the method according to the present disclosure, providing respective charging voltage further comprises: setting the cut-off voltage to a second voltage when the second charging mode is transmitted; recognizing the battery as a second type battery in response to the set second voltage; and providing a second charging voltage among respective charging voltages applicable to the recognized second type battery to the mobility device.

In at least one embodiment of the method according to the present disclosure, providing respective charging voltage further comprises: setting the cut-off voltage to a third voltage when the third charging mode is transmitted; recognizing the battery as a third type battery in response to the set third voltage; and providing a third charging voltage among respective charging voltages applicable to the recognized third type battery to the mobility device.

In at least one embodiment of the method according to the present disclosure, the method further includes receiving or extracting battery information from the mobility device under the control of the processor when the mobility device is electrically connected to the input/output interface.

In at least one embodiment of the method according to the present disclosure, providing respective charging voltage comprises setting the cut-off voltage to a second voltage or a third voltage based on the battery information when the fourth charging mode is transmitted.

In at least one embodiment of the method according to the present disclosure, providing respective charging voltage comprises: recognizing the battery as the second type battery in response to the transmitted second voltage when the set second voltage is transmitted; and providing a second charging voltage among respective charging voltages applicable to the recognized second type battery to the mobility device.

In at least one embodiment of the method according to the present disclosure, providing respective charging voltage comprises: recognizing, when the set third voltage is transmitted, the battery as a third type battery in response to the transmitted third voltage; and providing, to the mobility device, a third charging voltage among respective charging voltages applicable to the recognized third type battery.

In at least one embodiment of the method according to the present disclosure, the input/output interface comprises: a plurality of power terminals electrically connected to the mobility device; an indicator capable of displaying a charging state of the mobility device; and a connection unit capable of providing mobility information related to the mobility device.

As described above, the mobility charging device and the charging method according to an embodiment of the present disclosure may obtain battery information provided from the mobility device when the mobility device and the mobility charging device are connected to each other. The mobility charging device and the charging method may also provide a charging voltage according to the battery information, thereby safely charging the battery.

In addition, the mobility charging device and the charging method according to the present disclosure can improve reliability of a product by supplying charging voltage correspondingly to a battery when a mobility device and the mobility charging device are electrically connected.

Effects obtainable from the present disclosure are not limited to the above-mentioned. Other effects not mentioned should be clearly understood from the following description by those having ordinary skill in the art to which the present disclosure pertains.

### BRIEF DESCRIPTION OF THE DRAWINGS

FIG. 1 is a diagram for describing a mobility charging system according to an embodiment of the present disclosure.

FIG. 2 is a diagram for describing a mobility charging device according to an embodiment of the present disclosure.

FIG. 3 is a block diagram of a mobility charging device according to an embodiment.

FIG. 4 is a flowchart illustrating a method of charging using a mobility charging device according to an embodiment of the present disclosure.

### DETAILED DESCRIPTION

Hereinafter, the present disclosure should be described in detail with reference to embodiments and the accompanying drawings for better understanding of the present disclosure. However, embodiments according to the present disclosure may be modified in various forms, and the scope of the present disclosure should not be construed as being limited to the embodiments described below. Embodiments of the present disclosure are provided to more completely describe the present disclosure to a person having ordinary knowledge in the art.

In the description of the present embodiment, when each element is referred to as being formed “above” or “below” (on or under), the above or below (on or under) includes both that two elements are directly in contact with each other or that one or more other elements are indirectly formed between the two elements.

In addition, when expressed as “above” or “under”, it may include not only the upper direction but also the lower direction based on one element.

Further, relational terms such as “first” and “second”, “above/upper part/upper side”, and “below/lower part/lower side” used below may be used to distinguish one entity or element from another entity or element without necessarily requiring or implying any physical or logical relationship or order between such entities or elements.

When a component, device, element, or the like, of the present disclosure, is described as having a purpose or performing an operation, function, or the like, the component, device, or element should be considered herein as being “configured to” meet that purpose or to perform that operation or function.

Hereinafter, a mobility charging device and a charging method using the same according to an embodiment should be described with reference to the accompanying drawings.

For convenience, the mobility charging device and the charging method using the mobility charging device should be described using the Cartesian coordinate system (x-axis, y-axis, and z-axis), but may be described using other coordinate systems. In addition, according to the Cartesian coordinate system, the x-axis, the y-axis, and the z-axis are orthogonal to each other, but embodiments are not limited thereto.

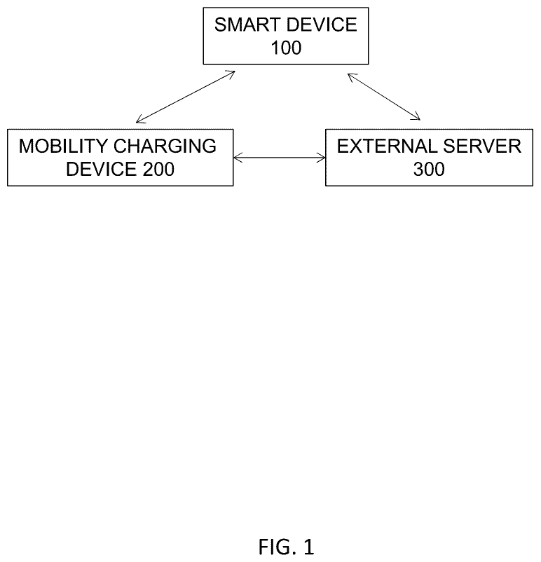

FIG. 1 is a diagram for describing a mobility charging system according to an embodiment of the present disclosure.

Referring to FIG. 1, the mobility charging system according to an embodiment may include a smart device 100, a mobility charging device 200, and an external server 300.

The smart device 100 is a device capable of executing an app through at least one application program, and may change or extend a partial function by using the application program. For example, the smart device 100 may execute an app or application related to a mobility device (e.g. a personal mobility device). Furthermore, the smart device 100 may transmit or share various mobility information or battery information to the mobility charging device 200 or the external server 300 by using wireless communication.

The mobility charging device 200 may have a controller 210 configured to store at least one application program and execute or control the at least one application program. In this embodiment, the controller 210 comprises a non-transitory computer-readable storage medium which stores the at least one application program. However, it is not limited thereto and it should be apparent to a person of ordinary skill in the art that the computer-readable medium may be provided separately from the controller 210. Also, the controller 210 may comprise a computer, a microprocessor, a central processing unit (CPU), an application specific integrated circuit (ASIC), a circuitry, logic circuits, and the like. Examples of the computer-readable medium include a hard disk drive (HDD), a solid-state drive (SSD), a silicon disk drive (SDD), a read-only memory (ROM), a random-access memory (RAM), a compact-disk (CD-ROM), a magnetic tape, a floppy disk, an optical data storage device, and the like.

When a mobility device is electrically connected under the control of the controller 210, the mobility charging device 200 may measure a voltage of a battery of the mobility device, determine one among a plurality of charging modes by applying the measured battery voltage to preset charging ranges set correspondingly to the plurality of charging modes, and set a cut-off voltage corresponding to the one of the plurality of charging modes. The mobility charging device 200 may provide the mobility device with charging voltage according to the cut-off voltage. A detailed description related to the mobile charging device 200 is described later.

In addition, the mobility charging device 200 may include a communication module. The mobility charging device 200 may share mobility information or battery information with the smart device 100 or the external server 300 by using the communication module.

The external server 300 may share the mobility information or the battery information with the smart device 100 or the mobility charging device 200 by using wireless communication. For example, the external server 300 may receive updated mobility information or updated battery information from a mobility device manufacturer or a battery manufacturer through wireless communication or wired communication, and may share the received information with the smart device 100 or the mobility charging device 200.

Here, the mobility information may include information on batteries installed in mobility devices.

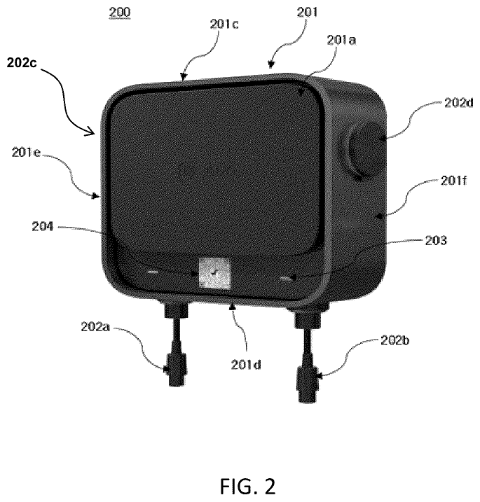

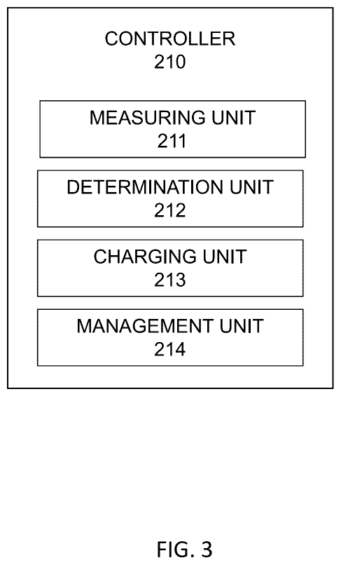

FIG. 2 is a diagram for describing a mobility charging system according to an embodiment, and FIG. 3 is a block diagram of the mobility charging device according to an embodiment.

Referring to FIG. 2, a mobility charging device 200 according to an embodiment may include a main body 201 having a predetermined size and a fixing unit (not shown) for fixing the main body 201.

The main body 201 may be formed in a rectangular parallelepiped shape or a hexahedron shape in which an inner space (not shown) of a certain size is provided. The main body 201 may have various components or the like capable of driving the mobility charging device 200 embedded in the inner space. For example, the controller 210 capable of entirely controlling the mobility charging device 200 may be disposed in the inner space of the main body 201.

The main body 201 may include a front surface 201a, a rear surface 201b, and a plurality of side surfaces 201c, 201d, 201e, and 201f.

The front surface 201a of the main body 201 may be disposed toward a first direction.

The rear surface 201b of the main body 201 may be disposed toward the first direction, and may be disposed toward a direction opposite to a direction in which the front surface 201a of the main body 201 is disposed. The rear surface 201b of the main body 201 may be spaced apart from the front surface 201a of the main body 201 with respect to the first direction. The rear surface 201b of the main body 201 may be spaced apart from the front surface 201a of the main body 201 by a predetermined thickness or a predetermined interval. For example, the first direction may be referred to as a Z direction, a thickness direction, or a height direction.

The plurality of side surfaces 201c, 201d, 201e, and 201f may be disposed between the front surface 201a of the main body 201 and the rear surface 201b of the main body 201. The plurality of side surfaces 201c, 201d, 201e, and 201f may include the first to the fourth side surfaces 201c to 201f.

The first side surface 201c may be disposed on the upper side of the main body 201 and may be disposed in a second direction.

The second side surface 201d may be disposed at a lower side of the main body 201 and may be disposed in a direction opposite to a direction in which the first side surface 201c is disposed. The second side surface 201d may be spaced apart from the first side surface 201c with respect to the second direction. For example, the second direction may be referred to as a Y direction or a length direction.

The third side surface 201e may be disposed on the left side of the main body 201 and may be disposed in a third direction.

The fourth side surface 201f may be disposed on the right side of the main body 201, and may be disposed in a direction opposite to a direction in which the third side surface 201e is disposed. The fourth side surface 201f may be disposed to be spaced apart from the third side surface 201e with respect to the third direction. For example, the third direction may be referred to as an X direction or a width direction. The third direction may intersect the second direction as a horizontal direction, and may intersect the first direction as a vertical direction.

In addition, the main body 201 may include input/output interfaces 202a, 202b, 202c, 202d, 203, and 204. The input/output interfaces 202a, 202b, 202c, 202d, 203, and 204 may include a plurality of power terminals 202a, 202b, 202c, and 202d, an indicator 203, and a connection unit 204.

The plurality of power terminals 202a, 202b, 202c, and 202d may include a first dedicated terminal 202a, a second dedicated terminal 202b, a first outlet (not shown but located on the side surface 201e opposite the second outlet 202d), and a second outlet 202d.

The first dedicated terminal 202a may provide a 24˜48V voltage to the mobility device when electrically connected with the mobility device. The first dedicated terminal 202a may be disposed on a left region of the second side surface 201d.

The second dedicated terminal 202b, when electrically connected with a mobility device, may provide a 24˜48V voltage to the mobility device. The second dedicated terminal 202b may be disposed on the right region of the second side surface 201d. The first dedicated terminal 202a and the second dedicated terminal 202b may be spaced apart from each other with respect to a third direction.

The first outlet and the second outlet 202d may provide each a 220V voltage, and may be disposed on the third side surface 201e and the fourth side surface 201f, respectively.

Although it has been described that the plurality of power terminals 202a, 202b, 202c, and 202d includes the first dedicated terminal 202a, the second dedicated terminal 202b, the first outlet, and the second outlet 202d, embodiments are not limited thereto. More dedicated terminals and outlets may be further included in some cases.

The indicator 203 may indicate the charging state of the mobility device. The indicator 203 may be disposed on a corner of the front surface 201a of the main body 201. For example, the indicator 203 may be disposed in a lower right or left corner on the front surface 201a of the main body 201.

The indicator 203 may include an LED or the like. The indicator 203 may display a charging state of the mobility device in different colors. For example, the indicator 203 may be displayed in a yellow color when the charging is waiting, may be displayed in a red color when the charging is being performed. The indicator 203 may be displayed in a green color when the charging is completed. The present disclosure is not limited thereto, and may be displayed in various colors.

Also, when the mobility charging device 200 is out of order, the indicator 203 may be displayed in red and may blink.

The connection unit 204 may provide mobility information associated with the mobility device. The connection unit 204 may be disposed on the front surface 201a of the main body 201. For example, the connection unit 204 may comprise a QR code.

For example, when the smart device 100 is close to the connection unit 204, the connection unit 204 may predict an expected charging completion time of the mobility device electrically connected to the mobility charging device 200. Furthermore, the connection unit 204 may provide the smart device 100 with predicted time information, information on a remaining battery capacity of the mobility device, automatic sensing information at the time of cable connection, charging progress status information, or the like. The charging progress state information may include display charging power, an amount of power, a charging time, and the like.

Although not illustrated, the input/output interfaces 202a, 202b, 202c, 202d, 203, and 204 may include a display unit for displaying mobility information. The display unit may be disposed on the front surface 201a of the main body 201. The display unit may display various information including mobility information, a charging state of the mobility device, a charging reservation list of the mobility device, and the like.

Also, the display unit may comprise a touch screen. For example, when a user searches for battery information or information of the mobility device through the display unit, the user may search for information of the mobility device, battery information of a battery installed in the mobility device, and the like under the control of the controller 210, and may display the searched information.

Although not shown, the fixing unit may be fastened to and fixed to a wall or an outer wall of a building. The fixing unit may be fastened to the rear surface 201b of the main body 201 to firmly fix the main body 201. For example, the main body 201 and the fixing unit may be fixed in a slide fastening manner. However, the fixing unit is not limited thereto, and may have any shape as long as it can fix the main body 201 to a wall or an outer wall of the building.

The main body 201 described so far may have the controller 210 embedded in or disposed in the inner space.

Referring to FIG. 3, the controller 210 may be disposed in the inner space of the main body 201 and control the mobility charging device 200 overall using at least one application program.

The controller 210 may include a measurement unit 211, a determination unit 212, a charging unit 213, and a battery management unit 214.

When the mobility device is electrically connected to the input/output interfaces 202a, 202b, 202c, 202d, 203, and 204, the measurement unit 211 may measure a voltage of the battery installed in the mobility device. The measurement unit 211 may measure the voltage of the battery in real time and provide the measured voltage to the determination unit 212.

The determination unit 212 may receive the measured voltage from the measurement unit 211 and apply the measured voltage to preset charging ranges to determine one of a plurality of charging mods.

The plurality of charging modes may include a first charging mode, a second charging mode, a third charging mode, and a fourth charging mode.

The determination unit 212 may determine the first charging mode when the measured voltage is included in a first charging range among the preset charging ranges. In this case, the first charging range may has the range of 22.4˜29.4 V.

The determination unit 212 may determine the second charging mode when the measured voltage is included in a second charging range. In this case, the second charging range may be 32˜42 V.

When the measured voltage is included in a third charging range, the determination unit 212 may determine the third charging mode. The third charging range may be 41.6˜54.6 V.

The determination unit 212 may determine the fourth charging mode when the charging mode is included in a charging range overlapping between the second charging range and the third charging range. The overlapping charging range may be approximately 41.6˜42 V.

The charging unit 213 may differently set the cut-off voltages corresponding to the plurality of charging modes, and may provide respective charging voltages corresponding to the cut-off voltages to the mobility device through the input/output interfaces 202a, 202b, 202c, 202d, 203, and 204.

For example, when the first charging mode is determined and transmitted from the determination unit 212, the charging unit 213 may set the cut-off voltage as a first voltage and recognize the battery as a first type battery in response to the set first voltage. The charging unit 213 may provide the first charging voltage to the mobility device. Here, the cut-off voltage may be set to the maximum voltage of the battery voltage range. In the first charging mode, the maximum voltage may be set to approximately 29.4 V with respect to the first charging range. Accordingly, the first voltage may be set to 29.4 V, which is the maximum voltage in the first charging range.

In other words, the charging unit 213 may recognize the battery as the first type battery based on the set 29.4 V. The first type battery may be a 24 V battery.

Accordingly, the charging unit 213 may provide the first charging voltage applicable to the recognized 24 V battery to the mobility device. The first charging voltage may be lower than 29.4 V.

In addition, when the second charging mode is determined and transmitted from the determination unit 212, the charging unit 213 may set the cut-off voltage as a second voltage and recognize the battery as a second type battery in response to the set second voltage. The charging unit 213 may provide a second charging voltage to the mobility device. Here, in the second charging mode, the maximum voltage may be set to approximately 42 V based on the second charging range. Accordingly, the second voltage may be set to 42 V, which is the maximum voltage in the second charging range.

In other words, the charging unit 213 may recognize the battery as the second type battery based on the set 42 V. The second type battery may be a 36 V battery.

Accordingly, the charging unit 213 may provide the second charging voltage applicable to the recognized 36 V battery to the mobility device. The second charging voltage may be lower than 42 V.

In addition, when the third charging mode is determined and transmitted from the determination unit 212, the charging unit 213 may set the cut-off voltage as a third voltage and recognize the battery as a third type battery in response to the set third voltage. The charging unit 213 may provide a third charging voltage to the mobility device. Here, in the third charging mode, the maximum voltage may be set to approximately 54.6 V based on a third charging range. Accordingly, the third voltage may be set to 54.6 V, which is the maximum voltage in the third charging range.

In other words, the charging unit 213 may recognize the battery as the third type battery based on the set 54.6 V. The third type battery may be a 48 V battery.

Accordingly, the charging unit 213 may provide a third charging voltage that may be applied to the recognized 48 V battery to the mobility device. The third charging voltage may be lower than 54.6 V.

When the mobility device is electrically connected to the input/output interface 202a, 202b, 202c, 202d, 203, 204, the battery management unit 214 may receive or extract battery information from the mobility device.

When the fourth charging mode is determined and transmitted from the determination unit 212, the battery management unit 214 may set the cut-off voltage as the second voltage or the third voltage based on the battery information. For example, when the fourth charging mode is transmitted and the provided battery information is a 36 V battery, the battery management unit 214 may set the cut-off voltage as the second voltage. The battery management unit 214 may set the cut-off voltage to the third voltage when the fourth charging mode is transmitted and the provided battery information is 48 V battery.

When the set second voltage is transmitted from the battery management unit 214, the charging unit 213 may recognize the battery as the second type battery in response to the transmitted second voltage. The charging unit 213 may provide a second charging voltage to the mobility device. Here, the second voltage may be set to 42 V, which is the maximum voltage in the second charging range.

In other words, the charging unit 213 may recognize the battery as a 36 V battery based on the set 42 V. Accordingly, the charging unit 213 may provide the mobility device with the second charging voltage applicable to the recognized 36 V battery. The second charging voltage may be lower than 42 V.

In addition, when the set third voltage is transmitted from the battery management unit 214, the charging unit 213 may recognize the battery as the third type battery in response to the transmitted third voltage. The charging unit 213 may provide a third charging voltage to the mobility device. Here, the third voltage may be set to 54.6 V, which is the maximum voltage in the third charging range.

In other words, the charging unit 213 may recognize the battery as a 48 V battery based on the set 54.6 V. Accordingly, the charging unit 213 may provide the third charging voltage that may be applied to the recognized 48 V battery to the mobility device. The third charging voltage may be lower than 54.6 V.

In addition, the controller 210 may control a short circuit protection function (short circuit recognition), a short circuit detection function, an overcurrent protection circuit function, a reverse polarity automatic protection function, an overcharge protection function, a protection function on abnormal circuit temperature, and the like by applying an application program so that the mobility charging device 200 may stably operate.

For example, the mobility charging device 200 may control to operate an Off circuit under the control of the controller 210 to prevent an overload when a charging rate is 90%.

In addition, the mobility charging device 200 may display an error recognition, a notification, and the like through the indicator 203 or the display unit or provide the error recognition, the notification, and the like to the smart device 100 under the control of the controller 210 when a leakage current occurs.

In addition, the mobility charging device 200 may block a charging voltage from being output or provided when an abnormality is detected while charging a mobility device under the control of the controller 210.

In addition, the mobility charging device 200 may reserve the connected mobility device to be charged at a specific time zone under the control of the controller 210.

In addition, the mobility charging device 200 may adjust a charging voltage and a charging current according to a battery rated voltage and a battery rated current of the mobility device electrically connected thereto under the control of the controller 210. In other words, the mobility charging device 200 may perform variable voltage conversion under the control of the controller 210.

In addition, the mobility charging device 200 may be waterproof and dustproof so as to withstand canopy when being installed outside.

In addition, the mobility charging device 200 may perform a charging status indicator using the indicator 203 under the control of the controller 210. The description thereof has been described above and is omitted.

In addition, the mobility charging device 200 may predict an expected charging completion time by analyzing a battery status and a charging speed of the mobility device which are electrically connected, under the control of the controller 210.

In addition, the mobility charging device 200 may check a remaining battery capacity of the mobility device which are electrically connected, under the control of the controller 210, and transmit the checked remaining battery capacity to the smart device 100.

In addition, the mobility charging device 200 may automatically detect an electrical connection of the mobility device, under the control of the controller 210.

The mobility charging device 200 according to the present disclosure described so far may be operated by connecting an external power source. For example, the mobility charging device 200 according to an embodiment of the present disclosure may be provided with an external power source using the 220V plug, and in some cases, a meter and a distribution box may be additionally configured.

In addition, although not illustrated, the mobility charging device 200 according to the present disclosure may retrieve the wires or cables physically connected to the mobility device in a reel manner when the charging is completed, under the condition electrically connected to the mobility device. However, it is not limited thereto.

In the present embodiment, the measurement unit 211, the determination unit 212, the charging unit 213, the battery management unit 214, and the display unit may each comprise a processor executing an installed program to perform its functionality described above and a computer-readable medium storing the program. Also, the processors of the units may be integrated into one or more processors.

A charging method using the mobility charging device 200 of the present disclosure described so far is as follows.

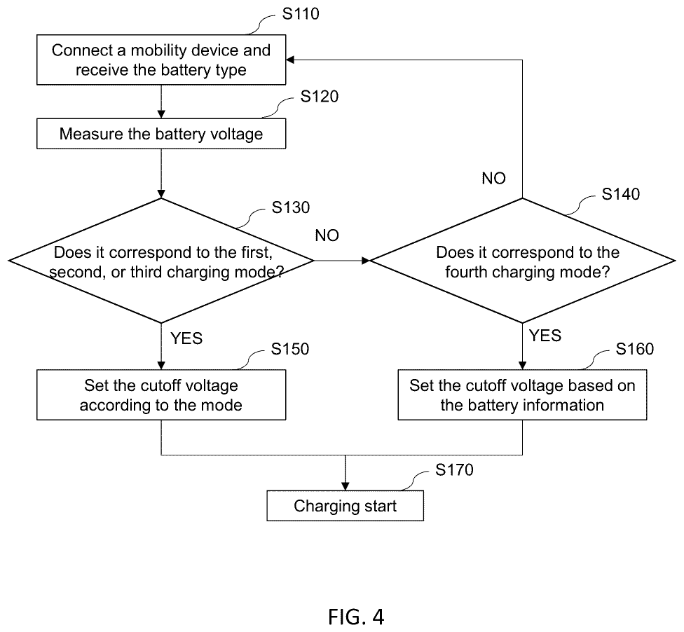

FIG. 4 is a flowchart illustrating a charging method using a mobility charging device according to an embodiment of the present disclosure.

Referring to FIG. 4, a mobility charging method according to an embodiment of the present disclosure is as follows.

The mobility device may be electrically connected to the input/output interfaces 202a, 202b, 202c, 202d, 203, and 204 of the mobility charging device 200 (S110). In other words, when the mobility device is electrically connected to the input/output interfaces 202a, 202b, 202c, 202d, 203, and 204, the mobility charging device 200 may be electrically connected to a battery installed on the mobility device. The mobility charging device 200 may receive or extract battery information from the mobility device under the control of the controller 210 (S110). The battery information may include a type of the battery.

The mobility charging device 200 may measure a voltage of a battery installed on the mobility device under the control of the controller 210 (S120).

Under the control of the controller 210, the mobility charging device 200 may receive the measured battery voltage and apply the measured battery voltage to a preset charging range to determine a plurality of charging modes (S130).

The mobility charging device 200 may differently set a cut-off voltage corresponding to the determined plurality of charging modes under the control of the controller 210. A plurality of charging modes may include a first charging mode, a second charging mode, a third charging mode, and a fourth charging mode.

The mobility charging device 200 may: determine a first charging mode when the measured voltage of the battery is included in a first charging range of the preset charging range (S130); determine a second charging mode when the measured voltage of the battery is included in a second charging range of the preset charging range (S130); determine a third charging mode when the measured voltage of the battery is included in a third charging range of the preset charging range (S130); and determine a fourth charging mode when the measured voltage of the battery is included in a charging range overlapping the second charging range and the third charging range of the preset charging range (S140). A detailed description thereof has been described above and is omitted.

When the first charging mode is transmitted, the mobility charging device 200 may set a cut-off as a first voltage (S150), and may recognize the battery as a first type battery in response to the set first voltage. The mobility charging device 200 may provide a first charging voltage among respective charging voltages that may be applied to the recognized first type battery to the mobility device parent device to charge the battery (S170).

When the second charging mode is transmitted, the mobility charging device 200 may set the cut-off to a second voltage (S150), and may recognize the battery as a second type battery in response to the set second voltage. The mobility charging device 200 may provide a second charging voltage from among respective charging voltages applicable to the recognized second type battery to the mobility device parent device to charge the battery (S170).

When the third charging mode is transmitted, the mobility charging device 200 may set the cut-off voltage to a third voltage (S150), and may recognize the battery as a third voltage in response to the set third voltage. The mobility charging device 200 may provide a third charging voltage among respective charging voltages applicable to the recognized third type battery to the mobility device to charge the battery (S170).

When the fourth charging mode is transmitted (S140), the mobility charging device 200 may set the cut-off voltage to the second voltage or the third voltage based on the battery information (S160).

When the set second voltage is transmitted, the mobility charging device 200 may recognize the battery as a second type battery in response to the transmitted second voltage, and may provide a second charging voltage among respective charging voltages applicable to the recognized second type battery to the mobility device, thereby performing charging (S170).

When the set third voltage is transmitted, the mobility charging device 200 may recognize the battery as a third type battery in response to the transmitted third voltage, and may provide a third charging voltage among respective charging voltages applicable to the recognized third type battery to the mobility device to charge the battery (S170).

As described above, the mobility charging device 200 may charge the mobility device by providing respective charging voltage corresponding to the differently set cut-off voltage to the mobility device through the input/output interfaces 202a, 202b, 202c, 202d, 203, 204, under the control of the controller 210 (S170).

The above-described present disclosure may be implemented as computer-readable codes in a program-recorded medium. The computer-readable medium includes all kinds of recording devices in which data readable by a computer system is stored. Examples of the computer-readable medium include a hard disk drive (HDD), solid state disk (SSD), silicon disk drive (SDD), ROM, RAM, CD-ROM, magnetic tape, floppy disk, optical data storage device, and the like.

Although the technical spirit of the present disclosure has been described with reference to the accompanying drawings, this illustrates an embodiment of the present disclosure, but the present disclosure is not limited thereto. In addition, it should be apparent to a person having ordinary skill in the art to which the present disclosure belongs that various modifications and imitations may be made without departing from the scope of the technical idea of the present disclosure.

### REFERENCE NUMBERS

100: Smart device
200: Mobility charging device
210: Processor
211: Measurement unit
212: Determination unit
213: Charging unit
214: Battery management unit
300: External server

What is claimed is:

1. A mobility charging device comprising:
a measurement unit configured to measure a voltage of a battery of a mobility device when the mobility device is electrically connected to an input/output interface;
a determination unit configured to receive the voltage of the battery from the measurement unit, and determine a charging mode among a plurality of charging modes according to the voltage of the battery; and
a charging unit configured to differently set cut-off voltages correspondingly to the plurality of charging modes, and provide charging voltage corresponding to a cut-off voltage set correspondingly to the charging mode to the mobility device through the input/output interface.

2. The mobility charging device of claim 1, wherein the plurality of charging modes includes a first charging mode, a second charging mode, a third charging mode, and a fourth charging mode,
wherein the determination unit is configured to:
determine the first charging mode when the measured voltage of the battery is included in a first charging range;
determine the second charging mode when the measured voltage of the battery is included in a second charging range;
determine the third charging mode when the measured voltage of the battery is included in a third charging range; and
determine the fourth charging mode when the measured voltage of the battery is included in a charging range overlapping between the second charging range and the third charging range.

3. The mobility charging device of claim 2, wherein, when the first charging mode is determined from the determination unit, the charging unit sets the cut-off voltage as a first voltage, recognizes the battery as a first type battery in response to the first voltage, and provides a first charging voltage to the mobility device.

4. The mobility charging device of claim 2, wherein, when the second charging mode is determined from the determination unit, the charging unit sets the cut-off voltage as a second voltage, recognizes the battery as a second type battery in response to the set second voltage, and provides a second charging voltage to the mobility device.

5. The mobility charging device of claim 2, wherein, when the third charging mode is determined from the determination unit, the charging unit sets the cut-off voltage as a third voltage, recognizes the battery as a third type battery in response to the set third voltage, and provides a third charging voltage to the mobility device.

6. The mobility charging device of claim 4, comprising a battery management unit configured to receive or extract battery information from the mobility device when the mobility device is electrically connected to the input/output interface.

7. The mobility charging device of claim 6, wherein, when the fourth charging mode is determined from the determination unit, the battery management unit is configured to set the cut-off voltage as a second voltage or a third voltage based on the battery information.

8. The mobility charging device of claim 7, wherein, when the second voltage set by the battery management unit is transmitted, the charging unit recognizes the battery as the second type battery in response to the transmitted second voltage, and provides a second charging voltage to the mobility device.

9. The mobility charging device of claim 7, wherein, when the third voltage set by the battery management unit is transmitted, the charging unit recognizes the battery as a third type battery in response to the transmitted third voltage, and provides a third charging voltage to the mobility device.

10. The mobility charging device of claim 1, wherein the input/output interface comprises:
a plurality of power terminals electrically connected to the mobility device;
an indicator configured to display a charging state of the mobility device; and
a connection unit configured to provide mobility information related to the mobility device.

11. A mobility charging method using a mobility charging device having a processor, the method comprising steps of:
measuring a voltage of a battery of the mobility device under the control of the processor when the mobility device is electrically connected to an input/output interface;
receiving the measured voltage of the battery under the control of the processor, and determining a charging mode among a plurality of charging modes according to the measured voltage of the battery;
differently setting cut-off voltages correspondingly to the plurality of determined charging modes under the control of the processor; and
providing charging voltage corresponding to a cut-off voltage set correspondingly to the charging mode to the mobility device through the input/output interface under the control of the processor.

12. The mobility charging method of claim 11, wherein the plurality of charging modes comprises a first charging mode, a second charging mode, a third charging mode, and a fourth charging mode, and the step of determining comprises:
determining the first charging mode when the measured voltage of the battery is included in a first charging range;
determining the second charging mode when the measured voltage of the battery is included in a second charging range; determining the third charging mode when the measured voltage of the battery is included in a third charging range; and determining the fourth charging mode when the measured voltage of the battery is included in a charging range overlapping between the second charging range and the third charging range.

13. The mobility charging method of claim 12, wherein the charging comprises:
setting the cut-off voltage to a first voltage when the first charging mode is determined;
recognizing the battery as a first type battery in response to the set first voltage; and
providing a first charging voltage to the mobility device.

14. The mobility charging method of claim 12, wherein the charging comprises:
setting the cut-off voltage to a second voltage when the second charging mode is determined;
recognizing the battery as a second type battery in response to the set second voltage; and
providing a second charging voltage to the mobility device.

15. The mobility charging method of claim 12, wherein the charging comprises:
setting the cut-off voltage to a third voltage when the third charging mode is determined;
recognizing the battery as a third type battery in response to the set third voltage; and
providing a third charging voltage to the mobility device.

16. The mobility charging method of claim 14, further comprising a step of receiving or extracting battery information from the mobility device under the control of the processor when the mobility device is electrically connected to the input/output interface.

17. The mobility charging method of claim 16, wherein the receiving comprises setting the cut-off voltage to a second voltage or a third voltage based on the battery information when the fourth charging mode is determined.

18. The mobility charging method of claim 17, wherein the charging comprises:
recognizing the battery as the second type battery in response to the transmitted second voltage when the set second voltage is transmitted; and
providing a second charging voltage to the mobility device.

19. The mobility charging method of claim 17, wherein the charging comprises:
recognizing, when the third voltage is transmitted, the battery as a third type battery in response to the transmitted third voltage; and
providing a third charging voltage to the mobility device.

20. The mobility charging method of claim 12, wherein the input/output interface comprises:
a plurality of power terminals electrically connected to the mobility device;
an indicator configured to display a charging state of the mobility device; and
a connection unit configured to provide mobility information related to the mobility device.
